(19) United States
(12) Patent Application Publication
(10) Pub. No.: US 2025/0129797 A1
(43) Pub. Date: Apr. 24, 2025

(54) ROTARY PUMP FOR CONVEYING PROCESS FLUID

(71) Applicant: Sulzer Management AG, Winterthur (CH)

(72) Inventors: Thomas KRÄNZLER, SALEM (DE); Thomas Welschinger, RADOLFZELL (DE)

(21) Appl. No.: 18/898,155

(22) Filed: Sep. 26, 2024

(30) Foreign Application Priority Data
Oct. 24, 2023 (EP) 23202740.9

(51) Int. Cl. F04D 29/66; F04D 1/06

(52) U.S. Cl. CPC F04D 29/669; F04D 1/06

(57) ABSTRACT

A rotary pump for conveying a process fluid includes a pump housing with an inlet and an outlet, a pump shaft to rotate about an axial direction, a hydraulic unit to convey and pressurize a process fluid, the hydraulic unit including an impeller fixedly mounted on the pump shaft. a balance device to balance an axial thrust generated by the hydraulic unit, the balance device including a balance disc fixedly connected to the pump shaft and having a rotary slide face, and a stationary part fixedly connected to the pump housing and having a stationary slide face, the rotary slide face and the stationary slide face facing each other, and a radial relief passage disposed between the rotary slide face and the stationary slide face, each of the rotary slide face and the stationary slide face comprising at least 30% by volume diamond.

### CROSS-REFERENCE TO RELATED APPLICATIONS

This application claims priority to European Application No. 23202740.9, filed Oct. 10, 2023, the contents which are hereby incorporated by reference.

### BACKGROUND

### Technical Field

The disclosure relates to a rotary pump for conveying a process fluid.

### Background Information

Conventional rotary pumps for conveying a fluid, for example a liquid such as water, can be used in many different industries. Examples are the oil and gas industry, the power generation industry, the chemical industry, the water industry or the pulp and paper industry. Rotary pumps have at least one impeller and a pump shaft for rotating the impeller. The at least one impeller can be configured for example as a radial impeller or as an axial or semi-axial impeller or as a helicoaxial impeller. Furthermore, the impeller can be configured as an open impeller or as a closed impeller, where a shroud is provided on the impeller, said shroud at least partially covering the vanes of the impeller.

A rotary pump can be designed as a single stage pump having only one impeller mounted to the shaft or as a multistage pump comprising a plurality of impellers, wherein the impellers are arranged one after another on the shaft. The impellers can be arranged in an in-line arrangement, where the axial thrust generated by a single impeller is directed in the same direction for all impellers, or in a back-to-back arrangement, where the axial thrust generated by a first group of impellers is directed in the opposite direction as the axial thrust generated by a second group of impellers.

Many rotary pumps include at least one balance device or balance system for at least partially balancing the axial thrust that is generated by the impeller(s) during operation of the pump. The balance device at least reduces the axial thrust that has to be carried by the axial bearing or the thrust bearing. Known balance devices comprise for example a balance drum or a balance disc.

The balance drum is fixedly connected to the pump shaft of the pump in a torque proof manner and furthermore, fixedly connected to the pump shaft with respect to the axial direction. A relief passage is disposed between the balance drum and a stationary part being stationary with respect to the pump housing. The relief passage extends in the axial direction from a front side of the balance drum to a back side of the balance drum. At the front side a high pressure prevails, e.g. the discharge pressure of the pump. The back side is usually connected to the suction side or a low pressure location of the pump by means of a balance line. Thus, during operation of the pump an axial force is generated by the balance drum counteracting the axial thrust generated by the impeller(s).

Other conventional balance devices comprise a balance disc. The balance disc works similar to a balance drum, however the relief passage extends usually in a radial direction perpendicular to the axial direction or in a direction oblique to the axial direction. The balance disk is fixedly connected to the pump shaft in a torque proof manner. Furthermore, the balance disk is fixedly connected to the pump shaft with respect to the axial direction. The balance disk cooperates with a counterpart arranged to face the balance disc. The counterpart is a stationary part, which is fixedly connected to the pump housing. The front side of the balance disc, which is the side facing the stationary counterpart, is exposed to a high pressure, e.g. the discharge pressure of the pump or a reduced discharge pressure, whereas the back side of the balance disc is connected to a low pressure, e.g. the suction pressure of the pump. Sometimes a throttle is disposed between the high pressure side and the front side of the balance disc and/or between the back side of the balance disc and the low pressure side of the pump.

Usually the balance disc comprises a rotary slide face and the stationary part comprises a stationary slide face facing the rotary slide face. The relief passage is disposed between the rotary slide face and the stationary slide face. If no measures are taken the stationary slide face and the rotary slide face abut against each other at standstill of the pump, i.e. when the pump does not generate any pressure. When the pump starts to generate pressure, the higher pressure at the front side of the balance disc pushes the balance disc and the pump shaft away from the stationary part, so that the radial relief passage opens between the stationary slide face and the rotary slide face.

The advantage of the balance disc as compared to the balance drum is the fact that the balance disc is self-regulating and completely balances the axial thrust generated by the impeller(s) so that no axial bearing is required for the pump shaft. When the pump e.g. operates at its nominal speed, the radial relief passage has a nominal width e.g. about 100 micrometer. If now for any reason the pressure at the front side increases, the balance disc is moved away from the stationary part in the axial direction, which in turn increases the width of the radial relief passage. Consequently, the pressure drop across the balance disc decreases and the balance disc is moved in the axial direction towards the stationary part. In this known manner the balance disc is self-regulating and can completely balance the axial thrust created by the rotating impeller(s).

### SUMMARY

It has been determined that one problem of the balance disc is dry running, in particular during start-up of the pump and also during shut down. If there is no fluid film between the rotary slide face and the stationary slide face or the fluid film is not sufficiently developed, dry friction or mixed friction occurs between the slide faces. Dry friction or mixed friction causes strong wear and a considerable generation of heat imposing heavy thermal stresses in the balance disc, the stationary part and other components of the pump.

Many material pairings have already been used for the rotary slide face and the stationary slide face, for example a high performance plastic such as the polymer PEEK (Polyether ether ketone) sliding along a hardened surface, or SiC (silicon carbide) sliding along SiC, hardened metal sliding along hardened metal or many other combinations of materials. However, all these material pairing do not provide really satisfying results.

To solve these problems it has been proposed to provide a lift-off device bridging the critical phases during start-up and shut down to avoid a direct physical contact between the balance disc and the stationary part. In order to ensure a contactless start-up and shut down of the pump, the lift-off device creates a displacement of the pump shaft in the axial direction, so that the rotary slide face and the stationary slide face do not touch each other. The displacement of the pump shaft can be generated, for example, by magnetic forces or by mechanical devices using spring forces for the displacement of the pump shaft. Such a mechanical lift-off device is for example disclosed in EP 3 832 143 A1.

However, providing a lift-off device for the pump shaft requires additional equipment, which increases the effort and the costs for manufacturing the pump. Staring from this prior art, it is therefore an object of the disclosure to propose a rotary pump for conveying a process fluid, having a balance device comprising a balance disc, wherein the balance device is exposed to a low wear without reducing the balancing of the axial thrust acting on the pump shaft during operation of the pump.

The subject matter of the disclosure satisfying this object is characterized by the features of the independent claim.

Thus, according to the disclosure, a rotary pump for conveying a process fluid is proposed, comprising a pump housing with an inlet for receiving the process fluid, an outlet for discharging the process fluid, a pump shaft configured for rotating about an axial direction, and a hydraulic unit for conveying and pressurizing the process fluid, wherein the hydraulic unit comprises at least one impeller fixedly mounted on the pump shaft, the pump further comprising a balance device for balancing an axial thrust generated by the hydraulic unit, the balance device comprising a balance disc fixedly connected to the pump shaft and having a rotary slide face, and a stationary part fixedly connected to the pump housing and having a stationary slide face, wherein the rotary slide face and the stationary slide face are facing each other, and wherein a radial relief passage is disposed between the rotary slide face and the stationary slide face. Each of the rotary slide face and the stationary slide face comprises at least 30% by volume diamond.

By providing both the rotary slide face of the balance disc and the stationary slide face of the stationary part with a content of diamond, which is at least 30% by volume the two slide faces have outstanding wear resistance and a very low friction coefficient, so that the two slide faces can slide along each other without a remarkable wear, even at dry running conditions. Thus, even if the rotary slide face and the rotary slide face are abutting against each other, so that there is dry friction or mixed friction between the two slide faces, there is no remarkable wear due to the very low friction coefficient of diamond and the high abrasion resistance of diamond. In addition, the high compressive stress strength of diamond ensures that the slide faces are not damaged, even if the two slide faces are sliding along each other with direct physical contact to each other.

In many applications the fluid film between the rotary slide face and the stationary slide face consists of the process fluid, i.e. the balance device is process fluid lubricated. For these applications the diamond containing stationary and rotary slide faces have the advantage that the process fluid can contain abrasive material, e.g. sand without jeopardizing the proper and reliable operation of the balance device.

Furthermore, it is no longer necessary to provide a lift-off device for creating a displacement of the pump shaft in the axial direction in particular during start-up and shut down to avoid a direct physical contact between the balance disc and the stationary part. The rotary pump according to the disclosure can be started and stopped with a direct physical contact of the stationary and the rotary slide face.

According to a preferred embodiment each of the rotary slide face and the stationary slide face is configured as an annular face.

There are several preferred possibilities to provide the rotary slide face and the stationary slide face with a diamond content of at least 30% by volume.

n some embodiments each of the rotary slide face and the stationary slide face is configured as a diamond face. In these embodiments the rotary and the stationary slide face consist completely of diamond, for example a thin layer of diamond is disposed on a base body to form the rotary slide face and the stationary slide face, respectively. The diamond layer can have a thickness of a few micrometer, for example two micrometer.

In some embodiments each of the rotary slide face and the stationary slide face comprises polycrystalline diamond.

According to a preferred embodiment, each of the rotary slide face and the stationary slide face comprises diamond particle reinforced silicon carbide, which is referred to hereinafter as Dia-SiC. Dia-Sic is a matrix composite, where diamond particles are embedded in a matric of silicon carbide (SiC). Besides its excellent hardness and strengths, Dia-SiC also has a very high thermal conductivity, for example up to 500 Watt per meter times Kelvin (W/m*K). The high thermal conductivity is advantageous to reliably remove the heat, which is for example created between the rotary slide surface and the stationary slide surface. Furthermore, Dia-SiC has a very low fretting tendency.

Particularly preferred, each of the rotary slide face and the stationary slide face consists of diamond particle reinforced silicon carbide (Dia-SiC). Due to the outstanding hardness of diamond the physical contact between the rotary slide face and the stationary slide face is—at least approximately—a pure diamond-diamond contact. If at the very beginning the contact between the rotary slide face and the stationary slide face is also based on non-diamond material, for example SiC, this non-diamond material is abraded quite quickly, so that the diamond material is then protruding the remainder of the respective slide surface. Thus, the remaining contact between the two slide faces is completely based on a diamond-diamond contact.

In some embodiments the balance disc comprises a rotary ring arranged in a annular groove and forming the rotary slide face, wherein the stationary part comprises a stationary ring arranged in a annular groove and forming the stationary slide face. The balance disc comprises the annular groove, which is arranged in that surface, which faces the stationary part. The stationary part comprises the annular groove, which is arranged in that surface, which faces the rotary part. The annular grooves are aligned with each other, such that the rotary ring arranged in the annular grove of the balance disc is aligned with the stationary ring in the annular groove of the stationary part. The surface of the rotary ring facing the stationary ring forms the rotary slide face, and the surface of the stationary ring facing the rotary ring forms the stationary slide face.

Preferably the rotary slide face of the rotary ring and the stationary slide face of the stationary ring are made of diamond particle reinforced silicon carbide (Dia-SiC).

In some embodiments the entire rotary ring and/or the entire stationary ring consists of Dia-SiC. In other embodiments both the rotary ring and the stationary ring comprise a carrier, on which a layer of Dia-SiC is provided, wherein the carrier is made of a different material than Dia-SiC, for example SiC.

In some embodiments the rotary ring comprises an annular notch extending along the circumference of the rotary ring, wherein a rotary inlay is arranged in the annular notch, the rotary inlay forming the rotary slide face.

In some embodiments the stationary ring comprises an annular notch extending along the circumference of the stationary ring, wherein a stationary inlay is arranged in the annular notch, the stationary inlay forming the stationary slide face. According to a preferred configuration of the embodiments having the rotary ring with the annular notch and the stationary ring with the annular notch, the rotary ring and the stationary ring are made of silicon carbide.

Preferably, the rotary inlay and the stationary inlay are made of diamond particle reinforced silicon carbide (Dia-SiC). In this configuration with the stationary inlay and the rotary inlay being made of Dia-SiC, the Dia-SiC inlays are embedded in the SiC rings.

Particularly preferred each of the rotary slide face and the stationary slide face comprises at least 50% by volume diamond.

Due to the outstanding tribological, mechanical and thermal properties of diamond, it is possible to configure the rotary pump such that the nominal width of the radial relief passage is considerably smaller compared to conventional rotary pumps. In the rotary pump according to the disclosure it is possible that the radial relief passage is configured to be at most 80 micrometer, preferably at most 50 micrometer, during operation of the rotary pump. Of course, the width of the radial relief passage can change during operation, however the width of the radial relief passage has a nominal value, which is for example the width of the radial relief passage or the mean value of said with, when the pump is operating at the nominal speed.

A smaller width of the radial relief passage is advantageous regarding the efficiency of the rotary pump. The leakage flow of the process fluid passing through the relief passage results in a decrease of the hydraulic performance or efficiency of the pump. Thus, reducing the width of the radial relief passage increases the efficiency of the pump.

Nowadays in many applications the most efficient use of the pump is strived for. It is desirable to have the highest possible ratio of the power, especially the hydraulic power, delivered by the pump to the power needed for driving the pump. This desire is mainly based upon an increased awareness of environment protection and a responsible dealing with the available resources as well as on the increasing costs of energy. Therefore, it is an advantage of the rotary pump according to the disclosure, that the radial relief gap can be configured with a smaller width.

In some embodiments the rotary pump is configured as a multistage centrifugal pump. In a multistage centrifugal pump the hydraulic unit comprises at least a first stage impeller, and a last stage impeller, and optionally at least one intermediate stage impeller, with each impeller fixedly mounted on the pump shaft. Further advantageous measures and embodiments of the disclosure will become apparent from the dependent claims.

### BRIEF DESCRIPTION OF THE DRAWINGS

The disclosure will be explained in more detail hereinafter with reference to embodiments of the disclosure and with reference to the drawings. There are shown in a schematic representation:

FIG. 1 isa schematic cross-sectional view of an embodiment of a rotary pump according to the disclosure,

FIG. 2 is an enlarged cross-sectional view illustrating the balance device,

FIG. 3 is a schematic cross-sectional view of a first embodiment of a rotary ring and a stationary ring of the balance device,

FIG. 4 is a schematic cross-sectional view of a second embodiment of a rotary ring and a stationary ring of the balance device, and

FIG. 5 is a schematic cross-sectional view of a third embodiment of a rotary ring and a stationary ring of the balance device.

### DETAILED DESCRIPTION

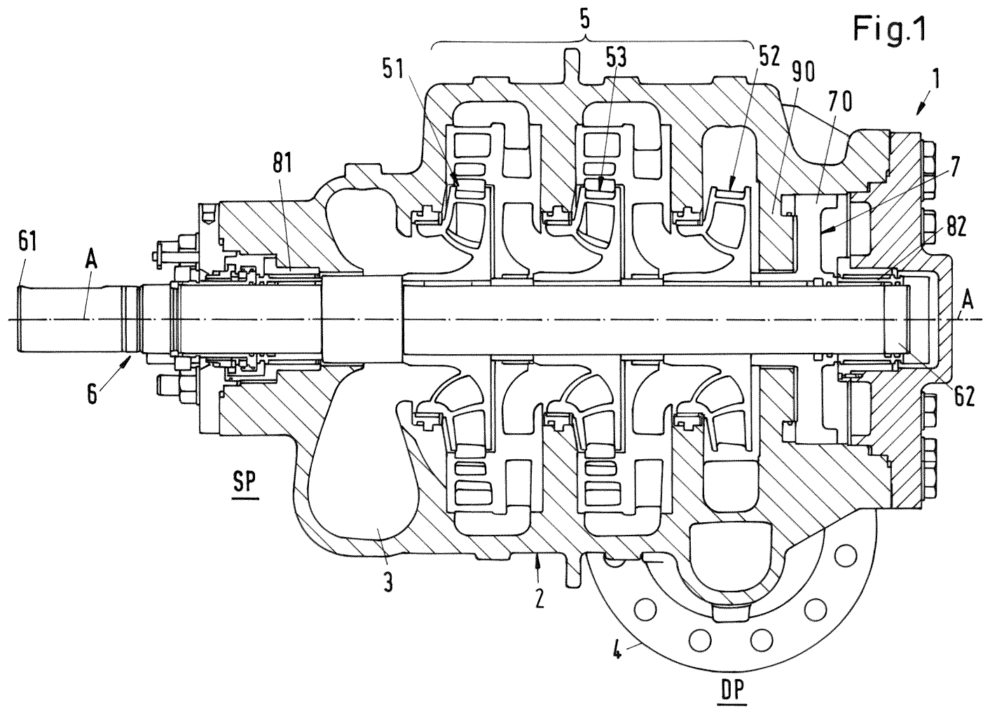

FIG. 1 shows a cross-sectional view of an embodiment of a rotary pump according to the disclosure, which is designated in its entity with reference numeral 1. The pump 1 is designed as a centrifugal pump for conveying a process fluid, for example a liquid such as water.

The rotary pump 1 comprises a pump housing 2 having an inlet 3 and an outlet 4 for the fluid to be conveyed. The inlet 3 is arranged on a suction side and receives the process fluid having a suction pressure SP. The outlet 4 is arranged on a discharge side and discharges the fluid having a discharge pressure DP, wherein the discharge pressure DP is larger than the suction pressure SP. The pump 1 further comprises a hydraulic unit 5 for conveying the process fluid from the inlet 3 to the outlet 4 and for pressurizing the process fluid from the suction pressure SP such that the fluid is discharged at the outlet 4 with the discharge pressure DP.

The hydraulic unit 5 comprises at least one impeller 51, 52, 53 for acting on the fluid.

The pump further comprises a pump shaft 6 for rotating each impeller 51, 52, 53 about an axial direction A. The axial direction A is defined by the axis of the pump shaft 6. A direction perpendicular to the axial direction A is referred to as a radial direction. The pump shaft 6 extends from a drive end 61 to a non-drive end 62. In this embodiment of the pump the drive end 61 of the pump shaft 6 is located outside of the pump housing 2 and can be connected to a drive unit (not shown) for driving the rotation of the pump shaft 6 about the axial direction A. The drive unit can comprise, for example, an electric motor. Each impeller 51, 52, 53 is mounted to the pump shaft 6 in a torque proof manner and furthermore, fixedly connected to the pump shaft 6 with respect to the axial direction A.

In the following description reference is made by way of example to an embodiment, which is suited for many applications, namely that the rotary pump 1 is configured as a multistage pump 1, wherein the hydraulic unit 5 comprises a plurality of impellers 51, 52, 53, namely at least a first stage impeller 51, a last stage impeller 52, and optionally at least one intermediate stage impeller 53, with each impeller 51, 52, 53 fixedly mounted on the pump shaft 6. The impellers 51, 52, 53 are arranged one after another on the pump shaft 6. The reference numeral 51 designates the first stage impeller, which is arranged closest to the inlet 3 for receiving the process fluid with the suction pressure SP. The reference numeral 52 designates the last stage impeller 52, which is the impeller 52 closest to the outlet 4. The last stage impeller 52 pressurizes the fluid such, that the fluid is discharged through the outlet 4 with the discharge pressure DP. The reference numeral 53 designates an intermediate stage impeller 53. Each intermediate stage impeller 53 is arranged between the first stage impeller 51 and the last stage impeller 52 when viewed in the direction of increasing pressure.

The embodiment shown in FIG. 1 has three stages, i.e. the hydraulic unit 5 comprises the first stage impeller 51, the last stage impeller 52 and one intermediate stage impellers 53. Of course, the number of three stages has to be understood exemplary. The plurality of impellers 51, 52, 53 can be arranged in an in-line configuration as shown in FIG. 1 or in a back-to-back configuration. In case of embodiments of the pump 1 as a single stage pump the hydraulic unit includes only one impeller constituting the first stage impeller 51 or the last stage impeller 52, respectively.

The multistage rotary pump 1 shown in FIG. 1 is designed as a horizontal pump, meaning that during operation the pump shaft 6 is extending horizontally, i.e. the axial direction A is perpendicular to the direction of gravity.

It has to be understood that the disclosure is not restricted to this types of rotary pump 1. In other embodiments, the rotary pump can be designed for example as a vertical pump, meaning that during operation the pump shaft 6 is extending in the vertical direction, which is the direction of gravity.

The rotary pump 1 comprises bearings on both sides of the hydraulic unit 5 (with respect to the axial direction A), i.e. the rotary pump 1 is designed as a between-bearing pump. A first radial bearing 81 and a second radial bearing 82 are provided for supporting the pump shaft 6. The first radial bearing 81 is arranged adjacent to the drive end 61 of the pump shaft 6. The second radial bearing 82 is arranged adjacent or at the non-drive end 62 of the pump shaft 6. The embodiment of the rotary pump 1 has no axial bearing, because the axial thrust generated by the impellers 51, 52, 53 is completely compensated by a balance device 7. In other embodiments, the rotary pump 1 is configured with at least one axial bearing.

The radial bearings 81, 82 are configured to support the pump shaft 6 in a radial direction perpendicular to the axial direction A. A radial bearing, such as the first or the second radial bearing 81 or 82 is also referred to as a “journal bearing”.

All bearings 81, 82 are preferably configured as antifriction bearings, such as ball bearings. Of course, it is also possible that some or all bearings 81, 82 are configured as hydrodynamic bearings. The bearings 81, 82 can be configured as process fluid lubricated bearings 81, 82, which are also referred to as process lubricated bearings (PLB). The term “process fluid lubricated pump” refers to pumps, where the process fluid that is conveyed by the pump 1 is used for the lubrication and the cooling of components of the pump, e.g. the bearings 81, 82. Thus, a process fluid lubricated pump 1 uses the process fluid itself or the modified (e.g. by a filtration process) process fluid for the lubrication and/or cooling of pump components. There is no separate lubricant required, e.g. an oil, for the lubrication and the cooling of the pump components, such as the bearings 81, 82. The advantage of the process fluid lubricated pump 1 is that it does not require a separate oil or fluid lubrication system as it is required in other types of pumps. When the pump is not lubricated by the process fluid or the modified process fluid, a shaft seal is required which separates the process fluid both from the environment and from the lubrication system filled with a lubricant different from the process fluid.

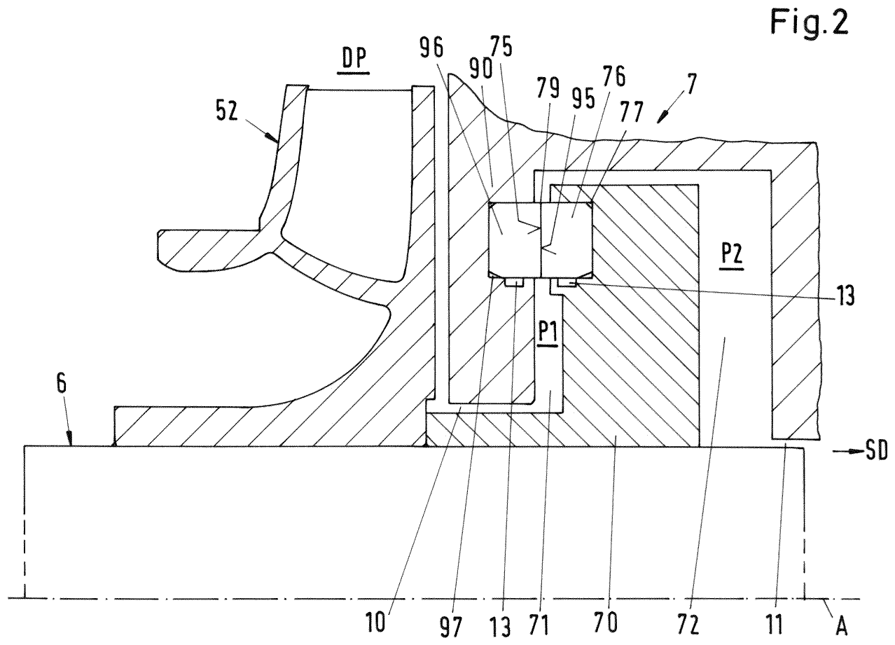

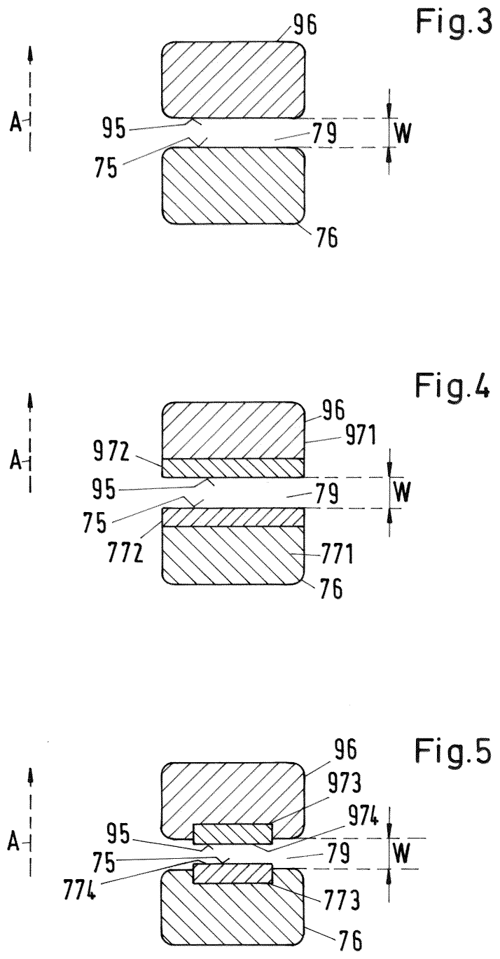

The rotary pump 1 further comprises the balance device 7, which will be explained in more detail referring to FIG. 2, which shows an enlarged cross-sectional view of the balance device 7. The balance device 7 is configured for balancing the axial thrust generated by the hydraulic unit 5, more precisely by the impellers 51, 52, 53. The balance device 7 comprises a balance disc 70 fixedly connected to the pump shaft 6 and having a rotary slide face 75. The balance device 7 further comprises a stationary part 90 fixedly connected to the pump housing 2 and having a stationary slide face 95, wherein the rotary slide face 75 and the stationary slide face 95 are facing each other. A radial relief passage 79 (see also FIG. 3) is arranged between the rotary slide face 75 and the stationary slide face 95.

Providing a balance disk 70 for compensating the axial thrust generated by the impellers 51, 52, 53 as such is known in the art and will therefore only briefly explained here.

The balance disc 70 is fixedly connected to the pump shaft 6 in a torque proof manner and furthermore, fixed to the pump shaft 6 with respect to the axial direction A such, that the balance disc 70 cannot move relative to the pump shaft 6 with respect to the axial direction A. Thus, the axial thrust generated by the impellers 51, 52, 53 can be compensated by the balance disc 70. The balance disc 70 is arranged between the hydraulic unit 5 and the non-drive end 62 of the pump shaft 6. The balance disc 70 defines a front side 71 and a back side 72. Both the front side 71 and the back side 72 are configured as annular chambers. The front side 71 is the side or the space facing the hydraulic unit 5. The back side 72 is the side or the space facing away from the hydraulic unit 5. The balance disc 70 is arranged adjacent to the stationary part 90, so that the stationary part 90 is arranged regarding the axial direction A between the hydraulic unit 5 and the balance disc 70.

The pump shaft 6 is configured to be movable with respect to the axial direction A so that the radial relief passage 79 is formed between the rotary slide face 75 and the stationary slide face 95. The radial relief passage 79 forms an annular gap between the stationary slide face 95 and the rotary slide face 75.

The radial relief passage 79 is also referred to as “radial gap” or as “radial labyrinth”. The term “radial” designates that the relief passage 79 extends in a radial direction, such that the process fluid passing through said radial relief passage 79 flows in a radial direction. It has to be noted that in other embodiments the radial relief passage is not extending exactly in the radial direction. i.e. perpendicular to the axial direction A, but can also be slanted both with respect to the axial direction A and with respect to the radial direction.

When the rotary pump 1 is at standstill, the rotary slide face 75 abuts against the stationary slide face 95. When the pump 1 starts, it generates pressure. Reference is now made to the operational state, where the pump 1 is working with its nominal speed, so that the discharge pressure DP prevails at the outlet 4 and the suction pressure SP prevails at the inlet 3.

The front side 71 is in fluid communication with the back side of the last stage impeller 52, where essentially the discharge pressure DP prevails. It is possible to arrange a first throttle passage 10 in said fluid communication so that the pressure P1 prevailing at the front side 71 is smaller than the discharge pressure DP. The back side 72 is in fluid communication with a low pressure location, for example with a location, where the suction pressure SP prevails. It is possible to arrange a second throttle passage 11 in said fluid communication so that the pressure P2 prevailing at the back side 72 is higher than the suction pressure SP. Of course, the P2 prevailing at the back side 72 is smaller than the pressure P1 prevailing at the front side 71. Thus, it is

$$D P \geq P 1 > P 2 \geq S P$$

The pressure difference P1-P2 across the balance disc 70 generates a force acting in the axial direction A and directed from the front side 71 to the back side 72, i.e. from the left to the right according to the representation in FIG. 2. This force counteracts and compensates the axial thrust generated by the impellers 51, 52, 53 during operation of the pump 1. The axial thrust generated by the impellers 51, 52, 53 is directed from the right to the left according to the representation in FIG. 2.

The balance disc 70 is self-regulating as it is known to the person skilled in the art. Therefore, it is not necessary to describe said self-regulation.

According to the disclosure each of the rotary slide face 75 and the stationary slide face 95 comprises at least 30% by volume diamond. It is preferred that the diamond content of both the rotary slide face 75 and the stationary slide face 95 is at least 50% by volume.

According to an embodiment, as it is shown in FIG. 2, the balance disc 70 comprises a rotary ring 76 arranged in an annular groove 77 and forming the rotary slide face 75. Furthermore, it is preferred that the stationary part 90 comprises a stationary ring 96 arranged in an annular groove 97 and forming the stationary slide face 95. The rotary ring 76 and the stationary ring 96 are aligned with each other, so that the rotary slide face 75 abuts against the stationary slide face 95 at standstill of the pump 1.

The annular grooves 77 and 97 can include a sealing element 13 to prevent the process fluid from entering into the respective annular groove 77, 97. The sealing element 13 is for example configured as an O-ring.

There are several possibilities to provide the rotary slide face 75 and the stationary slide face 95 with a diamond content of at least 30% in volume.

FIG. 3 shows a schematic cross-sectional view of a first embodiment of a rotary ring 76 and a stationary ring 96 of the balance device 7.

As it is shown in the cross-sectional view of the rotary ring 76 and the stationary ring 97 in FIG. 3, it is possible to configure the rotary ring 76 as a one-piece part, entirely consisting of the same material. Furthermore, it is possible to configure the stationary ring 96 as a one-piece part, entirely consisting of the same material, which can be the same or a different material as the material the rotary ring 76 is consisting of.

In particular, the rotary ring 76 and the stationary ring 96 can consist of polycrystalline diamond (PCD) or of diamond particle reinforced silicon carbide (Dia-SiC).

FIG. 4 shows a schematic cross-sectional view of a second embodiment of a rotary ring 76 and a stationary ring 96 of the balance device 7.

As it is shown in the cross-sectional view of the rotary ring 76 and the stationary ring 96 in FIG. 4, it is also possible to configure the rotary ring 76 and/or the stationary ring 96 with a base body 771, 971, on which a layer 772, 972 is provided, having a diamond content of at least 30% in volume The layer 772, 972 forms the rotary slide face 75 or the stationary slide face 95, respectively. Each of the layers 772, 972 can completely cover (as shown in FIG. 4) or partially cover the respective base body 771, 971.

Each layer 772, 972 can be configured as a diamond face, which is for example generated by a chemical vapor deposition (CVD) process. When the layer 772 and/or 972 is configured as a diamond face, the thickness of the layer 772, 972 is typically in the range of a few micrometers, e.g. two micrometer.

It is also possible that the layer 772 and/or the layer 972 consists of or includes Dia-SiC.

When the layer 772 or 972 is made of Dia-SiC, it is preferred that the respective base body 771, 971 consists of or includes SiC.

FIG. 5 shows a schematic cross-sectional view of a third embodiment of a rotary ring 76 and a stationary ring 96 of the balance device 7.

The rotary ring 76 comprises an annular notch 773 extending along the circumference of the rotary ring 76, and a rotary inlay 774 is arranged in the annular notch 773, the rotary inlay forming the rotary slide face 75.

The stationary ring 97 comprises an annular notch 973 extending along the circumference of the stationary ring 97, and wherein a stationary inlay 974 is arranged in the annular notch 973, the stationary inlay 974 forming the stationary slide face 95.

Preferably, the annular notch 773 of the rotary ring 76, has an extension in the radial direction which is smaller than the extension of the rotary ring 76 in the radial direction. Furthermore, it is preferred, that the annular notch 773 is arranged in the middle of the rotary ring 76 regarding the radial direction.

Furthermore, it is preferred that the annular notch 973 of the stationary ring 96 has an extension in the radial direction which is smaller than the extension of the stationary ring 96 in the radial direction. Furthermore, it is preferred, that the annular notch 973 is arranged in the middle of the stationary ring 96 regarding the radial direction.

Particularly preferred, both the rotary inlay 774 and the stationary inlay 974 are made of Dia-SiC.

When the stationary inlay 974 or the rotary inlay 774 is made of Dia-SiC the rotary ring 76 and the stationary ring 96 are made of silicon carbide, meaning that the rotary ring 76 and the stationary ring 96 are made of SiC, wherein the rotary inlay 774 and the stationary inlay 974 are made of Dia-SiC.

Due to the outstanding tribological, mechanical and thermal properties of diamond, it is possible to configure the rotary pump 1 such that the nominal width W of the radial relief passage 79 is considerably smaller compared to conventional rotary pumps. In the rotary pump 1 according to the disclosure it is possible that the radial relief passage 79 is configured to be at most 80 micrometers, preferably at most 50 micrometer, during operation of the rotary pump. Of course, the width W of the radial relief passage can change during operation, however the width W of the radial relief passage 79 has a nominal value, which is for example the width W of the radial relief passage 79 or the mean value of said with W, when the pump is operating at the nominal speed.

What is claimed is:

1. A rotary pump for conveying a process fluid, comprising:
a pump housing with an inlet configured to receive the process fluid and an outlet to discharge the process fluid;
a pump shaft configured to rotate about an axial direction;
a hydraulic unit to convey and pressurize the process fluid, the hydraulic unit comprising at least one impeller fixedly mounted on the pump shaft;
a balance device configured to balance an axial thrust generated by the hydraulic unit, the balance device comprising a balance disc fixedly connected to the pump shaft and having a rotary slide face, and a stationary part fixedly connected to the pump housing and having a stationary slide face, the rotary slide face and the stationary slide face facing each other; and
a radial relief passage disposed between the rotary slide face and the stationary slide face, each of the rotary slide face and the stationary slide face comprising at least 30% by volume diamond.

2. The rotary pump in accordance with claim 1, wherein each of the rotary slide face and the stationary slide face is an annular face.

3. The rotary pump in accordance with claim 1, wherein each of the rotary slide face and the stationary slide face is a diamond face.

4. The rotary pump in accordance with claim 1, wherein each of the rotary slide face and the stationary slide face comprises polycrystalline diamond.

5. The rotary pump in accordance with claim 1, wherein each of the rotary slide face and the stationary slide face comprises diamond particle reinforced silicon carbide.

6. The rotary pump in accordance with claim 5, wherein each of the rotary slide face and the stationary slide face consists of diamond particle reinforced silicon carbide.

7. The rotary pump in accordance with claim 1, wherein the balance disc comprises a rotary ring arranged in a first annular groove and forming the rotary slide face (75), and the stationary part comprises a stationary ring arranged in a second annular groove and forming the stationary slide face.

8. The rotary pump in accordance with claim 7, wherein the rotary slide face of the rotary ring and the stationary slide face of the stationary ring are made of diamond particle reinforced silicon carbide.

9. The rotary pump in accordance with claim 7, wherein the rotary ring comprises an annular notch extending along the circumference of the rotary ring, and a rotary inlay (774) is arranged in the annular notch, the rotary inlay forming the rotary slide face.

10. The rotary pump in accordance with claim 7 wherein the stationary ring comprises an annular notch extending along the circumference of the stationary ring, and a stationary inlay (974) is arranged in the annular notch, the stationary inlay forming the stationary slide face (95).

11. The rotary pump in accordance with claim 10, having the rotary ring with the annular notch and the stationary ring with the annular notch, wherein the rotary ring and the stationary ring are made of silicon carbide.

12. The rotary pump in accordance with claim 11, wherein the rotary inlay and the stationary inlay re made of diamond particle reinforced silicon carbide.

13. The rotary pump in accordance with claim 1, wherein each of the rotary slide face and the stationary slide face comprises at least 50% by volume diamond.

14. The rotary pump in accordance with claim 1, wherein the radial relief passage is configured to be at most 80 micrometers during operation of the rotary pump.

15. The rotary pump in accordance with claim 1, wherein the rotary pump is configured as a multistage centrifugal pump.

16. The rotary pump in accordance with claim 1, wherein the radial relief passage is configured to be at most 50 micrometers during operation of the rotary pump.
